(19) United States
(12) Patent Application Publication
(10) Pub. No.: US 2026/0180938 A1
(43) Pub. Date: Jun. 25, 2026

(54) METHODS FOR PROVIDING MESSAGE AND ELECTRONIC DEVICES SUPPORTING THE SAME

(71) Applicant: LINE Plus Corporation, Seongnam-si (KR)

(72) Inventors: Jisu LEE, Seongnam-si (KR); Sooyoung KIM, Seongnam-si (KR); Chungwoo LEE, Seongnam-si (KR); Dohun IM, Tokyo (JP)

(73) Assignee: LINE Plus Corporation, Seongnam-si (KR)

(21) Appl. No.: 19/430,415

(22) Filed: Dec. 23, 2025

(30) Foreign Application Priority Data
Dec. 23, 2024 (KR) 10-2024-0193913

(51) Int. Cl. H04L 51/04; G06N 3/02

(52) U.S. Cl. CPC H04L 51/04; G06N 3/02

(57) ABSTRACT

A method for providing a message, the method being executed by at least one processor, and the method including identifying an event associated with a message request based on an instant messaging application, obtaining second information from first information using an artificial neural network model, the first information being associated with a user account of the instant messaging application, and the second information being associated with at least one of a context associated with a timing of the identifying, or a prompt associated with the event, generating a first message based on the second information using the artificial neural network model, and providing the first message through a first message room of the instant messaging application associated with the artificial neural network model.

### CROSS-REFERENCE TO RELATED APPLICATION

This application claims priority to Korean Patent Application No. 10-2024-0193913, filed in the Korean Intellectual Property Office on Dec. 23, 2024, the entire contents of which are hereby incorporated by reference.

### BACKGROUND

### Field

Some example embodiments of the present disclosure relate to a method for providing a message and an electronic device supporting the same.

### Description of Related Art

Corresponding to the progress of digital convergence in which various information and communication technologies are combined, electronic devices provide various services grafted onto their pivotal functions. For example, the electronic device supports an instant message service that communicates with an external electronic device to exchange interactive messages. While executing the instant message service, the electronic device may record information input from a user or share the information with the external electronic device. A search and/or an appropriate reminder may be required or used for such recorded or shared information.

The above information is provided as background information for helping understanding of the present disclosure, and no assertion or determination is made as to whether it may be applied as prior art related to the present disclosure.

### SUMMARY

The present disclosure provides a method for providing a message and an electronic device supporting the same for addressing the above challenges.

The present disclosure may be implemented in various ways including a method, an electronic device, and/or a computer program stored in a non-transitory computer-readable recording medium.

In some example embodiments, a method for providing a message, the method being executed by at least one processor, includes identifying an event associated with a message request based on an instant messaging application, obtaining second information from first information using an artificial neural network model, the first information being associated with a user account of the instant messaging application, and the second information being associated with at least one of a context associated with a timing of the identifying, or a prompt associated with the event, generating a first message based on the second information using the artificial neural network model, and providing the first message through a first message room of the instant messaging application associated with the artificial neural network model.

In some example embodiments, the identifying may include providing a floating object on a first screen of the instant messaging application, receiving a first user input selecting the floating object, and identifying the receiving the first user input as the event.

In some example embodiments, the providing the floating object may include providing at least one of an icon, a logo, or a symbol associated with the artificial neural network model as the floating object.

In some example embodiments, the providing the floating object may include providing a second message associated with the context as the floating object.

In some example embodiments, the identifying may include receiving a second user input for entering the first message room based on the user account, and identifying the receiving the second user input as the event.

In some example embodiments, the identifying may include receiving a third user input inputting the prompt into the first message room of the instant messaging application, and identifying the receiving the third user input as the event.

In some example embodiments, the obtaining the second information may include identifying message information transmitted or received through at least one second message room of the instant messaging application associated with the user account as the first information.

In some example embodiments, the obtaining the second information may include identifying at least one of schedule information or memorandum information recorded through at least one service of the instant messaging application based on the user account as the first information.

In some example embodiments, the obtaining the second information may include identifying at least one of date information or weather information of the timing of the identifying as the context.

In some example embodiments, the obtaining the second information may include identifying the first information from a memory of an electronic device on which the instant messaging application is executed.

In some example embodiments, the obtaining the second information may include requesting at least a portion of the first information from an external electronic device associated with the instant messaging application, and receiving the at least the portion of the first information from the external electronic device.

In some example embodiments, the requesting the at least the portion of the first information may include transmitting keyword information associated with the at least one of the context or the prompt to the external electronic device.

In some example embodiments, the generating the first message may include identifying a third message associated with the second information from among a plurality of messages, the plurality of messages being transmitted or received through at least one second message room of the instant messaging application associated with the user account.

In some example embodiments, the providing the first message may include providing a fourth message including the third message together with the first message.

In some example embodiments, the providing the fourth message may include providing at least one of user account information or date information associated with transmission of the third message in an area of the fourth message.

In some example embodiments, the generating the first message may include generating a fifth message supporting access to a website associated with the second information.

In some example embodiments, the providing the first message may include providing the fifth message together with the first message.

In some example embodiments, the method may further include receiving a fourth user input selecting the first message, and providing the fifth message in response to receiving the fourth user input.

In some example embodiments, a non-transitory computer-readable recording medium storing a computer program that, when executed in a computer, causes the computer to perform the method.

In some example embodiments, an electronic device may include a memory storing instructions, and at least one processor configured to execute the instructions to cause the electronic device to identify an event associated with a message request based on an instant messaging application, obtain second information from first information using an artificial neural network model, the first information being associated with a user account of the instant messaging application, and the second information being associated with at least one of a context associated with a timing of identification of the event, or a prompt associated with the event, generate a first message based on the second information using the artificial neural network model, and provide the first message through a first message room of the instant messaging application associated with the artificial neural network model.

According to various examples of the present disclosure, a mechanism capable of executing a search function and/or a remind function for information recorded or shared during execution of an instant message service using an artificial neural network model may be provided.

The effects of the present disclosure are not limited to the above-mentioned effects, and other effects not mentioned will be clearly understood by those skilled in the art from the description of the claims.

### BRIEF DESCRIPTION OF DRAWINGS

Various examples of the present disclosure will be described with reference to the following drawings, and identical or similar reference numerals may be assigned to identical or corresponding components in connection with the description of the drawings.

FIG. 1 is a diagram illustrating an operation of an electronic device in a network environment according to some example embodiments of the present disclosure.

FIG. 2 is a diagram illustrating components of an electronic device in a network environment according to some example embodiments of the present disclosure.

FIG. 3 is a diagram illustrating identification of an event associated with a message request of an electronic device according to some example embodiments of the present disclosure.

FIG. 4 is a diagram illustrating a first scenario associated with message provision of an electronic device according to some example embodiments of the present disclosure.

FIG. 5 is a diagram illustrating a second scenario associated with message provision of an electronic device according to some example embodiments of the present disclosure.

FIG. 6 is a diagram illustrating a third scenario associated with message provision of an electronic device according to some example embodiments of the present disclosure.

FIG. 7 is a diagram illustrating a fourth scenario associated with message provision of an electronic device according to some example embodiments of the present disclosure.

FIG. 8 is a diagram illustrating a fifth scenario associated with message provision of an electronic device according to some example embodiments of the present disclosure.

FIG. 9 is a diagram illustrating a method for providing a message of an electronic device according to some example embodiments of the present disclosure.

### DETAILED DESCRIPTION

Hereinafter, specific details for the implementation of the present disclosure will be described in detail with reference to the accompanying drawings. However, in the following description, specific descriptions of well-known functions or configurations will be omitted if they may unnecessarily obscure the gist of the present disclosure.

In the accompanying drawings, identical or corresponding components are assigned identical (or similar) reference numerals. In addition, in the following description of some example embodiments, duplicate descriptions of identical or corresponding components may be omitted. However, even if descriptions of components are omitted in an example, it is not intended that such components are excluded from the example.

Advantages and features of the disclosed examples, and methods for achieving them, will become apparent with reference to some example embodiments described below in conjunction with the accompanying drawings. However, the present disclosure is not limited to the examples disclosed below, but may be implemented in various different forms, and these examples are provided only to make the present disclosure complete and to fully inform those skilled in the art of the scope of the inventive concepts.

Terms used in the present disclosure will be briefly described, and the disclosed examples will be described in detail. The terms used in the present disclosure have been selected from general terms currently widely used while considering functions in the present disclosure, but these may vary depending on the intention of a technician working in the related field, precedent, or emergence of new technology. Also, in specific cases, there are terms selected by the applicant, and in this case, the meaning will be described in detail in the description of the inventive concepts. Therefore, the terms used in the present disclosure should be defined based on the contents throughout the present disclosure, not merely the names of the terms.

Singular expressions used in the present disclosure include plural expressions unless the context clearly specifies it as singular. Also, plural expressions include singular expressions unless the context clearly specifies it as plural. Throughout the present disclosure, when a part is said to include a certain component, this means that it may further include other components, not excluding other components unless specifically stated to the contrary.

The term ‘module’ or ‘unit’ used in the present disclosure means a software or hardware component, and the ‘module’ or ‘unit’ performs certain roles. However, the ‘module’ or ‘unit’ is not limited to the meaning of software or hardware. The ‘module’ or ‘unit’ may be configured to reside in an addressable storage medium or may be configured to drive or reproduce one or more processors. Therefore, as an example, the ‘module’ or ‘unit’ may include at least one of components such as software components, object-oriented software components, class components, and task components, and processes, functions, attributes, procedures, subroutines, segments of program code, drivers, firmware, microcode, circuitry, data, databases, data structures, tables, arrays, or variables. Functions provided within components and ‘modules’ or ‘units’ may be combined into a smaller number of components and ‘modules’ or ‘units’ or may be further separated into additional components and ‘modules’ or ‘units’.

According to some example embodiments, the ‘module’ or ‘unit’ may be implemented as a processor and a memory. The ‘processor’ should be interpreted broadly to include a general-purpose processor, a Central Processing Unit (CPU), a microprocessor, a Digital Signal Processor (DSP), a controller, a microcontroller, a state machine, and the like. In some environments, the ‘processor’ may refer to an Application Specific Integrated Circuit (ASIC), a Programmable Logic Device (PLD), a Field Programmable Gate Array (FPGA), and the like. The ‘processor’ may refer to a combination of processing devices, such as, for example, a combination of a DSP and a microprocessor, a combination of a plurality of microprocessors, a combination of one or more microprocessors combined with a DSP core, or a combination of any other such configurations. Also, the ‘memory’ should be interpreted broadly to include any electronic component capable of storing electronic information. The ‘memory’ may refer to various types of processor-readable media such as Random Access Memory (RAM), Read-Only Memory (ROM), Non-Volatile Random Access Memory (NVRAM), Programmable Read-Only Memory (PROM), Erasable Programmable Read-Only Memory (EPROM), Electrically Erasable PROM (EEPROM), flash memory, magnetic or marking data storage, registers, and the like. If the processor may read information from the memory and/or record information to the memory, the memory is said to be in electronic communication with the processor. A memory integrated into the processor is in electronic communication with the processor.

Terms such as first, second, A, B, (a), (b), etc. used in the present disclosure are merely used to distinguish one component from another, and the essence, order, or sequence of the corresponding component is not limited by the terms.

In the present disclosure, when a component is described as being ‘connected’, ‘coupled’, or ‘accessed’ to another component, the component may be directly connected or accessed to the other component, but it should be understood that another component may be ‘connected’, ‘coupled’, or ‘accessed’ between each component.

‘Comprise’ and/or ‘comprising’ used in the present disclosure does not exclude the presence or addition of one or more other components, operations, and/or elements to the mentioned components, operations, and/or elements.

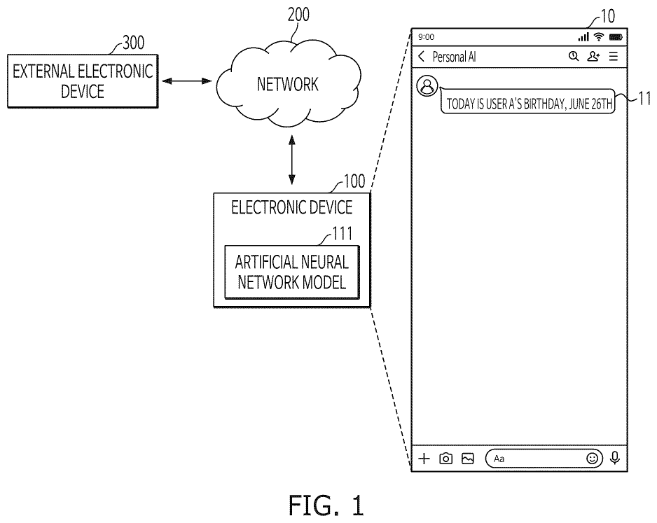

FIG. 1 is a diagram illustrating an operation of an electronic device in a network environment according to some example embodiments of the present disclosure.

Referring to FIG. 1, an electronic device 100 according to some example embodiments may generate and provide a first message 11 using an artificial neural network model 111. The first message 11 may be based on first information recorded, transmitted, and/or received in association with a user account accessing an instant messaging application while executing the corresponding application. For example, the electronic device 100 may identify an event associated with a request for the first message 11, and in response thereto, monitor the first information using the artificial neural network model 111, thereby generating and providing the first message 11 including second information that is at least a portion of the corresponding first information. In some example embodiments, the user account accessing the instant messaging application may be referred to as an online identity generated for a user of the electronic device 100 to use functions and/or services supported by the corresponding application and/or data associated therewith.

In some example embodiments, the electronic device 100 may provide the first message 11 generated using the artificial neural network model 111 to a first message room 10 (or a chat room) defined in the instant messaging application. For example, the electronic device 100 may display the first message 11 through the first message room 10 where an intelligent assistant (or an agent) representing the artificial neural network model 111 has accessed (or participated) in the instant messaging application. According to some example embodiments, the first message room 10 may have an always-active state in the instant messaging application, or be controlled to an archive state and switched to an active state when providing the first message 11.

According to some example embodiments, the electronic device 100 may obtain first information based on the user account of the instant messaging application to generate and provide the first message 11 using the artificial neural network model 111. In this regard, the first information recorded, transmitted, and/or received based on the user account upon execution of the instant messaging application may be stored in an external electronic device 300 (e.g., a system and/or a server associated with the instant messaging application) communication-connected with the electronic device 100 through a network 200. In some example embodiments, the electronic device 100 may request and obtain the first information from the external electronic device 300 in response to identifying the event associated with the request for the first message 11. For example, the electronic device 100 may request and obtain the first information recorded and existing through various services (e.g., a calendar service, a memorandum service (also referred to herein as a memo service that provides memo information), an album (e.g., photo album) service, etc.) supported by the instant messaging application from the external electronic device 300. Also, the electronic device 100 may request and obtain the first information transmitted and/or received in at least one second message room where the online identity corresponding to the user account of the instant messaging application has accessed (or participated) and which exists, from the external electronic device 300.

According to some example embodiments, in an operation of requesting the first information based on the user account of the instant messaging application from the external electronic device 300, the electronic device 100 may request and obtain all of the first information stored in the external electronic device 300, or request and obtain only first information generated within a specified period range (e.g., time range) from a request time point (e.g., from a timing of an event associated with a message request). Alternatively or additionally, in the operation of requesting the first information, the electronic device 100 may transmit a context (e.g., a date and/or weather) associated with a timing of identification of the event and/or keyword information (or a parameter) indicating a prompt according to a user input identified as at least a portion of the event occurrence to the external electronic device 300. In this case, the electronic device 100 may receive and obtain only first information associated with the corresponding keyword from the external electronic device 300.

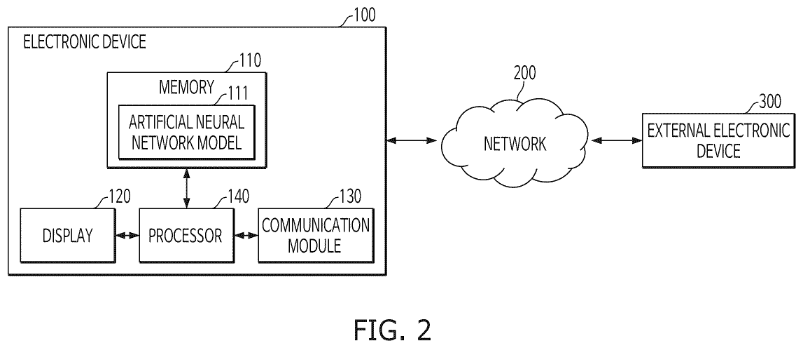

In some example embodiments, the first information recorded, transmitted, and/or received based on the user account upon execution of the instant messaging application may be stored in a memory (e.g., memory 110 of FIG. 2) of the electronic device 100 where the corresponding application is executed (or stored). In some example embodiments, the electronic device 100 may obtain at least a portion of the first information loaded from the memory 110 in response to identifying the event associated with the request for the first message 11. Alternatively, only a portion of the first information recorded, transmitted, and/or received based on the user account of the instant messaging application (e.g., information satisfying a valid period associated with storage) may be stored in the memory 110 of the electronic device 100, and all of the first information may be stored in the external electronic device 300. In this case, the electronic device 100 may monitor the portion of the first information stored in the memory 110, and if information usable for generating the first message 11 is not identified through the corresponding monitoring, request and obtain the remaining first information from the external electronic device 300.

In some example embodiments, the electronic device 100 may obtain second information from the first information using the artificial neural network model 111. According to some example embodiments, the electronic device 100 may obtain second information usable for generating the first message 11 among the first information, for example, meaningful second information with respect to the context associated with the timing of identification of the event and/or the prompt associated with the event, using the artificial neural network model 111. In other words, the electronic device 100 may obtain at least one piece of second information constituting contents of the first message 11 from the first information obtained from the external electronic device 300 or the memory 110 using the artificial neural network model 111. In some example embodiments, the electronic device 100 may generate the first message 11 based on the at least one piece of second information using the artificial neural network model 111, and provide the corresponding first message 11 through the first message room 10 of the instant messaging application. According to some example embodiments, the second information may represent the result of a search of the first information for information relevant to the event. According to some example embodiments, the second information may include a reminder based on the first information.

According to some example embodiments, operations described herein as being performed by the electronic device 100 and/or the external electronic device 300 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a Central Processing Unit (CPU), an Arithmetic Logic Unit (ALU), a Graphics Processing Unit (GPU), a digital signal processor, a microcomputer, a Field Programmable Gate Array (FPGA), a System-on-Chip (SoC), a programmable logic unit, a microprocessor, Application-Specific Integrated Circuit (ASIC), etc.

According to some example embodiments, the processing circuitry may perform some operations (e.g., the operations described herein as being performed by the artificial neural network model 111) by artificial intelligence and/or machine learning. As an example, the processing circuitry may implement an artificial neural network (e.g., the artificial neural network model 111) that is trained on a set of training data by, for example, a supervised, unsupervised, and/or reinforcement learning model, and wherein the processing circuitry may process a feature vector to provide output based upon the training. Such artificial neural networks may utilize a variety of artificial neural network organizational and processing models, such as Convolutional Neural Networks (CNN), Recurrent Neural Networks (RNN) optionally including Long Short-Term Memory (LSTM) units and/or Gated Recurrent Units (GRU), Stacking-based Deep Neural Networks (S-DNN), State-Space Dynamic Neural Networks (S-SDNN), deconvolution networks, Deep Belief Networks (DBN), and/or Restricted Boltzmann Machines (RBM). Alternatively or additionally, the processing circuitry may include other forms of artificial intelligence and/or machine learning, such as, for example, linear and/or logistic regression, statistical clustering, Bayesian classification, decision trees, dimensionality reduction such as principal component analysis, and expert systems; and/or combinations thereof, including ensembles such as random forests.

Herein, a machine learning model (e.g., the artificial neural network model 111) may have any structure that is trainable, e.g., with training data. For example, the machine learning model may include an artificial neural network, a decision tree, a support vector machine, a Bayesian network, a genetic algorithm, and/or the like. The machine learning model will now be described by mainly referring to an artificial neural network, but some example embodiments are not limited thereto. Non-limiting examples of the artificial neural network may include a Convolution Neural Network (CNN), a Region based Convolution Neural Network (R-CNN), a Region Proposal Network (RPN), a Recurrent Neural Network (RNN), a Stacking-based Deep Neural Network (S-DNN), a State-Space Dynamic Neural Network (S-SDNN), a deconvolution network, a Deep Belief Network (DBN), a Restricted Boltzmann Machine (RBM), a fully convolutional network, a Long Short-Term Memory (LSTM) network, a classification network, and/or the like.

FIG. 2 is a diagram illustrating components of an electronic device in a network environment according to some example embodiments of the present disclosure.

Referring to FIG. 2, an electronic device 100 according to some example embodiments may include various types of devices capable of storing, providing, and executing computer-executable programs and data associated with a data processing service (e.g., an instant messaging application-based message providing service). For example, the electronic device 100 may include at least one of a system device, a server device, a distributed computing device based on a cloud service, or a mobile communication device.

In some example embodiments, the electronic device 100 may communicate with at least one external electronic device 300. For example, the electronic device 100 may communicate with at least one external electronic device 300 through the network 200. In some example embodiments, the network 200 may be configured as a wired network including at least one of Ethernet, a Power Line Communication (PLC), a telephone line communication device, or RS-serial communication, a wireless network including at least one of a mobile communication network, a Wireless Local Area Network LAN (WLAN), Wi-Fi, Bluetooth, or ZigBee, or a combination thereof, depending on an installation environment. In some example embodiments, a communication method between the electronic device 100 and the at least one external electronic device 300 is not limited, and may include not only a communication method utilizing a communication network (e.g., a mobile communication network, wired Internet, wireless Internet, a broadcasting network, and/or a satellite network) that the network 200 may support, but also a short-range wireless communication method between the electronic device 100 and the at least one external electronic device 300.

In some example embodiments, the electronic device 100 may include components associated with execution and/or provision of the data processing service. For example, the electronic device 100 may include a memory 110, a display 120, a communication module 130, and at least one processor 140. According to some example embodiments, at least some of the components included in the electronic device 100 may be connected to each other through a bus, a General Purpose Input and Output (GPIO), a Serial Peripheral Interface (SPI), or a Mobile Industry Processor Interface (MIPI) to exchange signals (e.g., commands or data). According to some example embodiments, operations described herein as being performed by the at least one processor 140 and/or the communication module 130 may be performed using processing circuitry.

In some example embodiments, the memory 110 may include any computer-readable non-transitory recording medium. According to some example embodiments, the memory 110 may include a permanent mass storage device such as a Read Only Memory (ROM), a disk drive, a Solid State Drive (SSD), and/or a flash memory. In some example embodiments, the permanent mass storage device such as the ROM, SSD, flash memory, and/or disk drive may be included in the electronic device 100 as a separate permanent storage device distinct from the memory 110.

In some example embodiments, an operating system, at least one application program, and/or at least one program code may be stored in the memory 110. In some example embodiments, these software components may be loaded from a computer-readable recording medium distinct from the memory 110. Such a recording medium may include a recording medium directly connectable to the electronic device 100, and may include, for example, a floppy drive, a disk, a tape, a DVD/CD-ROM drive, and/or a memory card. Alternatively, the software components may be loaded into the memory 110 through the communication module 130. For example, at least one program may be loaded into the memory 110 based on a computer program installed by files provided by a file distribution system through the network 200.

In some example embodiments, the memory 110 may store instructions associated with functional operations of the components of the electronic device 100. For example, the memory 110 may store instructions that, when executed by the at least one processor 140, cause the components of the electronic device 100 to perform defined functional operations.

According to some example embodiments, the memory 110 may include the artificial neural network model 111. For example, the memory 110 may include the artificial neural network model 111 configured with a multi-layer neural network structure including an input layer, a hidden layer, and an output layer to execute a statistical algorithm. In some example embodiments, the artificial neural network model 111 may include a deep learning model and/or a machine learning model learned (or trained) so that artificial neurons (or nodes) forming a network by combination of synapses adjust weights of the synapses and improve output performance for a specific input. According to some example embodiments, the artificial neural network model 111 may include at least one of a Large Language Model (LLM), a Small Language Model (SLM), a Large Multimodal Model (LMM), or Retrieval Augmented Generation (RAG).

In some example embodiments, at least a portion of the display 120 may be exposed outside of the electronic device 100 to visually provide various contents. For example, the display 120 may output (or display) an execution screen and/or a user interface of at least one application included in the electronic device 100. In this regard, the display 120 may include a display driving integrated circuit that receives and processes a driving signal corresponding to image information from the at least one processor 140. Also, the display 120 may include a touch panel (or a touch sensing circuit), and may sense various types of user inputs based on the touch panel and output corresponding electrical signals.

In some example embodiments, the communication module 130 may provide a configuration or function for the electronic device 100 to communicate with the at least one external electronic device 300 through the network 200. For example, the communication module 130 may establish communication (or a communication channel) according to a specified communication protocol with at least one external electronic device, and perform transmission and reception of signals, data, and/or information through the corresponding communication. According to some example embodiments, the communication module 130 may include a wireless communication module (e.g., a cellular communication module, a short-range wireless communication module, and/or a Global Navigation Satellite System (GNSS) communication module) and a wired communication module (e.g., a Local Area Network (LAN) communication module and/or a power line communication module). Such a wireless communication module and wired communication module may be configured as separate chips or integrated into a single chip.

In some example embodiments, the at least one processor 140 may be configured to process instructions of a computer program provided by the memory 110 and/or the communication module 130 by performing basic arithmetic, logic, and input/output operations. For example, the at least one processor 140 may be configured to execute instructions received according to program code stored in the memory 110 and/or instructions received from the at least one external electronic device 300 through the communication module 130 and the network 200. Some example embodiments of the present disclosure described below may be implemented by the at least one processor 140 executing instructions (or code) of a computer program.

According to some example embodiments, the at least one processor 140 may be configured to execute a data processing application (e.g., an instant messaging application) for providing the data processing service. For example, the at least one processor 140 may execute the data processing application by executing computer program code (or instructions) loaded into the memory 110. In some example embodiments, the at least one processor 140 may receive signals, data, and/or information transmitted from the at least one external electronic device 300 through the communication module 130 while executing the data processing application, and may process the corresponding signals, data, and/or information and store them in the memory 110. Also, the at least one processor 140 may transmit signals, data, and/or information generated while executing the data processing application to the at least one external electronic device 300 through the communication module 130.

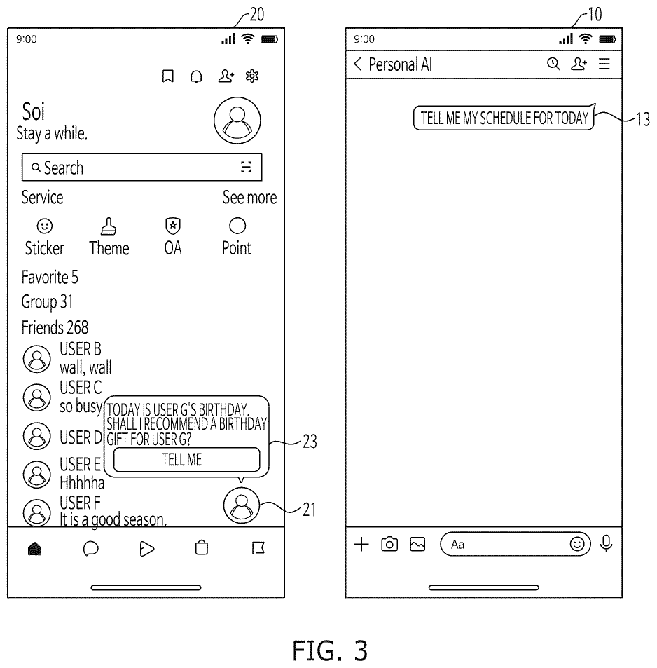

FIG. 3 is a diagram illustrating identification of an event associated with a message request of an electronic device according to some example embodiments of the present disclosure.

Referring to FIG. 3, an electronic device (e.g., the electronic device 100 of FIG. 1 and/or FIG. 2) according to some example embodiments may identify an occurrence of an event associated with a request (e.g., generation and provision) for a first message (e.g., the first message 11 of FIG. 1). In this regard, the electronic device 100 may provide a first floating object 21 (e.g., a graphical object, icon, etc.) representing an intelligent assistant (or an agent) associated with an artificial neural network model (e.g., the artificial neural network model 111 of FIG. 1 and/or FIG. 2) upon execution of the instant messaging application. For example, the electronic device 100 may overlay and provide (or display) the first floating object 21 on (e.g., overlaying) an area of a main screen 20 (also referred to herein as a main screen) of the instant messaging application. Here, the main screen 20 of the instant messaging application is a screen displayed first upon execution of the corresponding application, and may include at least one message room list, a notification status, and an interface element for starting a new message. According to some example embodiments, the first floating object 21 may represent the intelligent assistant (or agent) or include at least one of an icon, a logo, or a symbol associated with the intelligent assistant. Alternatively, the electronic device 100 may provide a second floating object 23 (e.g., graphical object, text box, conversation box, messaging interface, etc.) on the main screen 20 of the instant messaging application upon execution of the corresponding application. For example, the electronic device 100 may provide the second floating object 23 based on a context (e.g., a date and/or weather) associated with an execution time point of the instant messaging application. According to some example embodiments, the second floating object 23 may include a second message generated by the artificial neural network model 111. In this regard, the electronic device 100 may obtain second information (e.g., anniversary information and/or weather information) corresponding to the context upon execution of the instant messaging application. For example, the electronic device 100 may obtain first information (e.g., information shared in at least one second message room accessed by the online identity corresponding to the user account) using the artificial neural network model 111, and obtain the second information from the corresponding first information. Alternatively, the electronic device 100 may obtain second information provided from a service (e.g., schedule information and/or date information from a calendar service, memorandum information from a memo service, and/or weather information from a weather service) of the instant messaging application. According to some example embodiments, the second information provided from the service of the instant messaging application may include information recorded in the corresponding service based on the user account and/or information supported according to a policy of the corresponding service. In some example embodiments, the electronic device 100 may generate a second message based on the obtained second information using the artificial neural network model 111, and provide the corresponding second message as the second floating object 23 on the main screen 20 of the instant messaging application.

In some example embodiments, the first floating object 21 and/or the second floating object 23 are not constrained to a fixed position on the main screen 20 of the instant messaging application, but may be displayed in a form floating on a specific area of the main screen 20, and may be elements for directly accessing a specific function or displaying specific information.

According to some example embodiments, the electronic device 100 may provide the first floating object 21 and the second floating object 23 together on the main screen 20 of the instant messaging application, or provide only one floating object. In some example embodiments, when the first floating object 21 and the second floating object 23 are provided together, a shape of at least one of the icon, logo, or symbol corresponding to the first floating object 21 may be variably configured according to the context and/or the second information associated with the generation of the second floating object 23. In some example embodiments, the electronic device 100 may receive a first user input selecting the first floating object 21 or the second floating object 23, and in response thereto, identify that the event associated with the request for the first message 11 has occurred.

In some example embodiments, the electronic device 100 may receive a second user input for entering the first message room 10 of the instant messaging application. For example, the electronic device 100 may receive a second user input for entering the first message room 10 where the intelligent assistant (or agent) representing the artificial neural network model 111 has accessed (or participated) based on the user account (or online identity) of the instant messaging application. According to some example embodiments, the electronic device 100 may identify that the event associated with the request for the first message 11 has occurred in response to receiving the second user input. Alternatively or additionally, the electronic device 100 may receive a third user input inputting a prompt 13 associated with a specific inquiry and/or request in the first message room 10 of the instant messaging application, and may identify that the event associated with the request for the first message 11 has occurred in response to receiving the corresponding third user input.

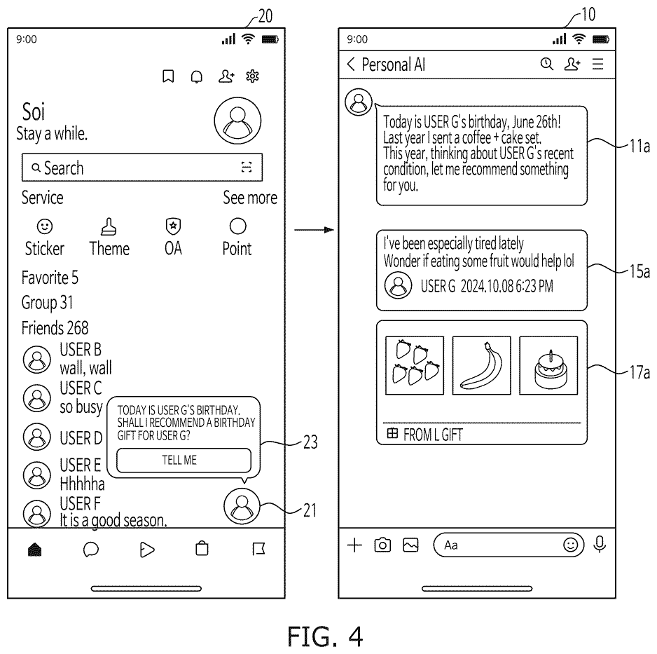

FIG. 4 is a diagram illustrating a first scenario associated with message provision of an electronic device according to some example embodiments of the present disclosure.

Referring to FIG. 4, an electronic device (e.g., the electronic device 100 of FIG. 1 and/or FIG. 2) according to some example embodiments may receive a first user input selecting the first floating object 21 and/or the second floating object 23 provided through the main screen 20 of the instant messaging application. In some example embodiments, the first floating object 21 and/or the second floating object 23 may function as an entry point for the first message room 10 where the intelligent assistant (or agent) representing the artificial neural network model (e.g., the artificial neural network model 111 of FIG. 1 and/or FIG. 2) has accessed (or participated), and the electronic device 100 may provide the first message room 10 in response to receiving the first user input.

In some example embodiments, the electronic device 100 may provide a first message 11a generated through the artificial neural network model 111 through the first message room 10. In this regard, when the first floating object 21 is selected by the first user input, the electronic device 100 may obtain second information (e.g., anniversary information) corresponding to a context (e.g., a date) associated with a timing of identification of the corresponding event (e.g., reception of the first user input) from a service (e.g., a calendar service and/or a memo service) associated with the instant messaging application. Also, the electronic device 100 may obtain first information (e.g., information shared in at least one second message room accessed by the online identity corresponding to the user account) using the artificial neural network model 111 and monitor it, thereby obtaining second information corresponding to the context from the corresponding first information. In some example embodiments, the electronic device 100 may generate and provide the first message 11a based on the second information using the artificial neural network model 111. If the second floating object 23 is selected by the first user input, the electronic device 100 may generate and provide the first message 11a based on the second information used when generating the second message corresponding to the corresponding second floating object 23.

According to some example embodiments, the first message 11a generated using the artificial neural network model 111 may be configured to include contents indicating information (e.g., an anniversary) associated with the context (e.g., the date) and/or additional information (e.g., identification information of a target person, history information, and/or recommendation information) associated with the context, according to an attribute (or a category) of the second information.

According to some example embodiments, the electronic device 100 may provide a fourth message 15a together in an operation of providing the first message 11a. For example, the electronic device 100 may provide the fourth message 15a including information referenced in the generation of the first message 11a to the first message room 10. In this regard, the electronic device 100 may identify a third message that may be referenced in the generation of the first message 11a from the first information (e.g., information shared in at least one second message room accessed by the online identity corresponding to the user account) using the artificial neural network model 111. In some example embodiments, the electronic device 100 may generate and provide the fourth message 15a including the identified third message (or contents included in the third message), account information (or identification information) of a target person who transmitted the corresponding third message, and/or transmission date information of the corresponding third message to the first message room 10.

According to some example embodiments, the electronic device 100 may provide a fifth message 17a together in the operation of providing the first message 11a. For example, when the first message 11a includes contents associated with a proposal and/or recommendation of the intelligent assistant (or agent) corresponding to the artificial neural network model 111, the electronic device 100 may generate and provide the fifth message 17a supporting access to a specific website or web page. In this regard, the electronic device 100 may collect information associated with an attribute (or a category) of the second information (e.g., anniversary information) and/or contents included in the fourth message 15a using the artificial neural network model 111, and generate the fifth message 17a functioning as a link, a deep link, an embedded link, and/or a framing link for a website or web page associated with a source of the corresponding information. In some example embodiments, the fifth message 17a may be configured to include a snippet and/or a thumbnail associated with the collected information.

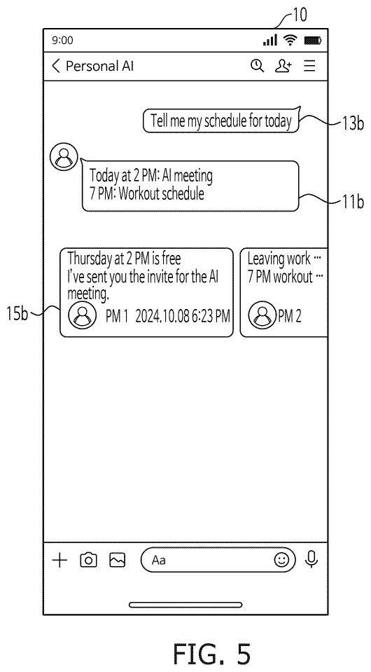

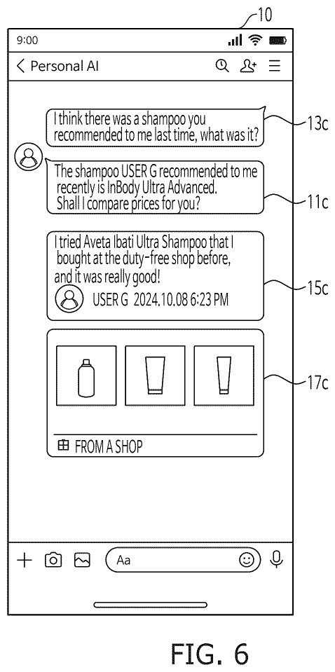

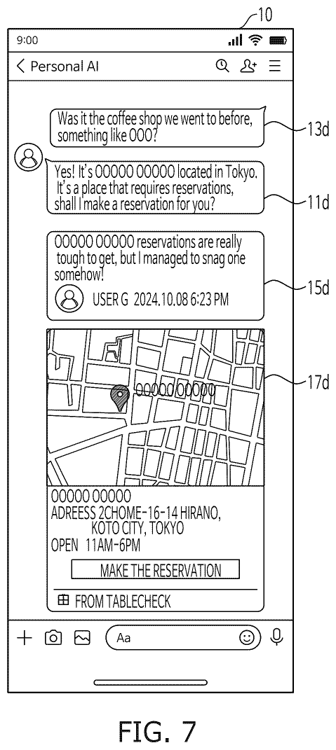

FIG. 5 is a diagram illustrating a second scenario associated with message provision of an electronic device according to some example embodiments of the present disclosure. FIG. 6 is a diagram illustrating a third scenario associated with message provision of an electronic device according to some example embodiments of the present disclosure. FIG. 7 is a diagram illustrating a fourth scenario associated with message provision of an electronic device according to some example embodiments of the present disclosure.

Referring to FIG. 5, an electronic device (e.g., the electronic device 100 of FIG. 1 and/or FIG. 2) according to some example embodiments may receive a third user input inputting a prompt 13b associated with a specific inquiry and/or request in the first message room 10 of the instant messaging application where the intelligent assistant (or agent) corresponding to the artificial neural network model (e.g., the artificial neural network model 111 of FIG. 1 and/or FIG. 2) has accessed. In response thereto, the electronic device 100 may divide contents included in the corresponding prompt 13b into grammatical units (e.g., words, phrases, and/or morphemes) based on execution of the artificial neural network model 111, and analyze grammatical elements or linguistic features for each unit to identify a domain, meaning, and/or parameter associated with the prompt 13b.

In some example embodiments, the electronic device 100 may generate and provide a first message 11b responding to the prompt 13b using the artificial neural network model 111. In this regard, the electronic device 100 may obtain first information (e.g., information shared in at least one second message room accessed by the online identity corresponding to the user account) using the artificial neural network model 111, and obtain second information associated with the prompt 13b from the corresponding first information. Also, the electronic device 100 may obtain second information associated with the prompt 13b provided from a service (e.g., a calendar service and/or a memo service) of the instant messaging application. In some example embodiments, the electronic device 100 may generate and provide the first message 11b based on the second information using the artificial neural network model 111.

In some example embodiments, the electronic device 100 may generate and provide the first message 11b together with a fourth message 15b including information referenced in the generation of the corresponding first message 11b. In this regard, the electronic device 100 may identify a third message associated with the second information from the first information (e.g., information shared in at least one second message room accessed by the online identity corresponding to the user account and/or information recorded through a service of the instant messaging application) using the artificial neural network model 111. In some example embodiments, the electronic device 100 may generate and provide the fourth message 15b including the identified third message (or contents included in the third message), account information (or identification information) of a target person who transmitted the corresponding third message, and/or transmission date information of the corresponding third message to the first message room 10.

Referring to FIGS. 6 and 7, the electronic device 100 may identify a domain, meaning, and/or parameter associated with a prompt 13c or 13d inputted into the first message room 10 using the artificial neural network model 111, and generate and provide a first message 11c or 11d responding to the corresponding prompt 13c or 13d and a fourth message 15c or 15d including information referenced in the generation of the corresponding first message 11c or 11d. Also, when the first message 11c or 11d includes contents associated with a proposal and/or recommendation of the intelligent assistant (or agent) corresponding to the artificial neural network model 111, the electronic device 100 may collect information associated with the parameter of the prompt 13c or 13d, an attribute (or a category) of second information (e.g., product information or place information) used when generating the first message 11c or 11d, and/or contents included in the fourth message 15c or 15d, and generate and provide a fifth message 17c or 17d supporting access to a website or web page associated with a source of the corresponding information.

In some example embodiments, the fifth message 17c or 17d may be selectively provided based on a fourth user input. For example, when the first message 11c or 11d includes contents associated with a proposal and/or recommendation of the intelligent assistant (or agent) corresponding to the artificial neural network model 111, the electronic device 100 may provide the fifth message 17c or 17d in response to receiving a fourth user input selecting the first message 11c or 11d.

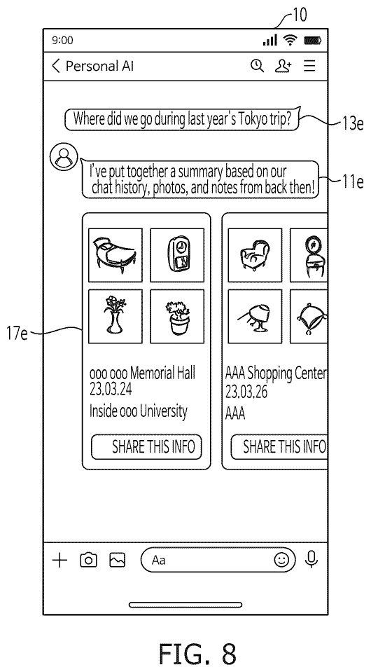

FIG. 8 is a diagram illustrating a fifth scenario associated with message provision of an electronic device according to some example embodiments of the present disclosure.

Referring to FIG. 8, an electronic device (e.g., the electronic device 100 of FIG. 1 and/or FIG. 2) according to some example embodiments may provide a first message 11e corresponding to a prompt 13e inputted into the first message room 10 together with a fifth message 17e using an artificial neural network model (e.g., the artificial neural network model 111 of FIG. 1 and/or FIG. 2). For example, when second information including information associated with a domain, intention, and/or parameter of the prompt 13e as metadata is obtained from first information (e.g., information shared in at least one second message room accessed by the online identity corresponding to the user account and/or information recorded through a service of the instant messaging application) obtained using the artificial neural network model 111, the electronic device 100 may generate and provide contents (e.g., an image and/or a video) corresponding to the corresponding second information as the fifth message 17e.

According to some example embodiments, the electronic device 100 may receive a fifth user input selecting the fifth message 17e. In response thereto, the electronic device 100 may enlarge and display the contents included in the fifth message 17e, or provide a screen of a second message room or a screen of a service (e.g., an album service) of the instant messaging application where second information associated with the corresponding contents exists. Alternatively, the electronic device 100 may display a plurality of contents included in the fifth message 17e with a specified graphic effect (e.g., a slide show).

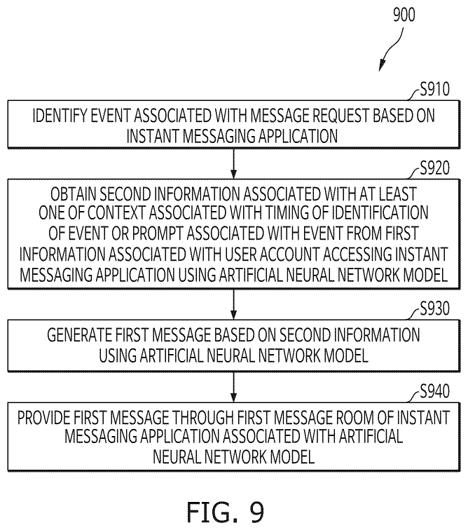

FIG. 9 is a diagram illustrating a method for providing a message of an electronic device according to some example embodiments of the present disclosure.

Operations of a method for providing a message 900 described in the example of FIG. 9 may be performed sequentially or non-sequentially. For example, an order in which the operations described in the example of FIG. 9 are performed may be changed, some operations may be performed repeatedly, or at least two operations may be performed in parallel. Also, at least some of the operations described in the example of FIG. 9 may include operations identical or similar to the operations of the electronic device described through the preceding drawings, and redundant descriptions of identical or similar operations may be omitted below.

Referring to FIG. 9, in operation S910, an electronic device (e.g., the electronic device 100 of FIG. 1 and/or FIG. 2) according to some example embodiments may identify an event associated with a request (e.g., generation and provision) for a first message based on an instant messaging application. In this regard, the electronic device 100 may provide a first floating object of an icon, logo, and/or symbol type representing an intelligent assistant (or agent) associated with an artificial neural network model (e.g., the artificial neural network model 111 of FIG. 1 and/or FIG. 2) in an area of a main screen of the instant messaging application. Alternatively or additionally, the electronic device 100 may provide a second floating object of a second message type generated by the artificial neural network model 111 based on second information (e.g., anniversary information and/or weather information) corresponding to a context (e.g., a date and/or weather) of an execution time point of the instant messaging application together with the first floating object. In some example embodiments, the electronic device 100 may receive a first user input selecting the first floating object or the second floating object, and in response thereto, identify that the event associated with the request for the first message has occurred. Alternatively or additionally, when the electronic device 100 receives a second user input for entering a first message room where the intelligent assistant (or agent) representing the artificial neural network model 111 has accessed (or participated) based on the user account (or online identity) of the instant messaging application, or receives a third user input inputting a prompt associated with a specific inquiry and/or request in the corresponding first message room, it may identify that the event associated with the request for the first message has occurred.

In operation S920, the electronic device 100 according to some example embodiments may obtain second information associated with at least one of a context associated with a timing of identification of the event or a prompt associated with the event from first information associated with a user account accessing the instant messaging application using the artificial neural network model 111. In this regard, the electronic device 100 may obtain first information (e.g., information shared in at least one second message room accessed by the online identity corresponding to the user account and/or information recorded through a service of the instant messaging application based on the user account) based on execution of the artificial neural network model 111. According to some example embodiments, when the event is identified by the reception of the first user input for the first floating object or the second floating object, or the reception of the second user input for entering the first message room, the electronic device 100 may obtain second information associated with a context corresponding to the identification time point of the corresponding event from the obtained first information. Alternatively, when the event is identified by the third user input inputting the prompt in the first message room, the electronic device 100 may obtain second information associated with a domain, intention, and/or parameter of the prompt from the obtained first information.

In operation S930, the electronic device 100 according to some example embodiments may generate a first message based on the second information using the artificial neural network model 111. For example, the electronic device 100 may generate the first message composed of contents indicating context information based on the second information and/or contents indicating response information to the prompt. According to some example embodiments, the first message may include contents indicating additional information associated with the context and/or prompt according to an attribute (or a category) of the second information.

In operation S940, the electronic device 100 according to some example embodiments may provide the first message through the first message room of the instant messaging application associated with the artificial neural network model. For example, the electronic device 100 may display the first message in the first message room where the intelligent assistant (or agent) representing the artificial neural network model 111 has accessed (or participated).

According to some example embodiments, the electronic device 100 may provide a fourth message together with the first message. In this regard, the electronic device 100 may identify a third message that may be referenced in the generation of the first message or is associated with the second information from the first information through execution of the artificial neural network model 111, and generate and provide the fourth message including the corresponding third message (or contents included in the third message), account information (or identification information) of a target person (e.g., user account information) who transmitted the corresponding third message, and/or transmission date information of the corresponding third message to the first message room. According to some example embodiments, at least one of user account information or data information associated with transmission of the third message may be provided in an area of the fourth message.

According to some example embodiments, the electronic device 100 may provide a fifth message together with the first message. For example, when the first message includes contents associated with a proposal and/or recommendation of the intelligent assistant (or agent) corresponding to the artificial neural network model 111, the electronic device 100 may collect information associated with the parameter of the prompt, the attribute (or category) of the second information used when generating the first message, and/or contents included in the fourth message, and generate and provide the fifth message supporting access to a website or web page associated with a source of the corresponding information.

Conventional devices and methods for performing an instant message service involve recording message information communicated over the instant message service. However, the conventional devices and methods are unable to utilize the recorded message information to provide search and/or reminder functionality.

According to some example embodiments, improved devices and methods are provided for performing an instant message service. For example, the improved devices and methods use an artificial neural network model to obtain second information from first information associated with a user account of an instant messaging application, and generate an instant message based on the second information. Therefore, the improved devices and methods overcome the deficiencies of the conventional devices and methods to at least provide search and/or reminder functionality.

The above-described method may be provided as a non-transitory computer-readable recording medium storing a computer program for execution on a computer. The medium may continuously store a computer-executable program, or temporarily store it for execution or download. Also, the medium may be various recording means or storage means in a form where a single or several hardware are combined, and is not limited to a medium directly accessed to any computer system, but may be distributed on a network. Examples of the medium may include magnetic media such as a hard disk, a floppy disk, and a magnetic tape, optical recording media such as a CD-ROM and a DVD, magneto-optical media such as a floptical disk, and things configured to store program instructions including a ROM, a RAM, a flash memory, and the like. Also, as examples of other media, there may be recording media or storage media managed by an app store distributing applications, or sites or servers supplying or distributing various other software.

The methods, operations, or techniques of the present disclosure may be implemented by various means. For example, these techniques may be implemented by hardware, or a combination of hardware with firmware or software. Those skilled in the art will understand that various illustrative logical blocks, modules, circuits, and algorithm operations described in connection with the disclosure herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design requirements (or configurations) imposed on the overall system. Those skilled in the art may implement the described functionality in various ways for each particular application, but such implementations should not be interpreted as causing a departure from the scope of the present disclosure.

In a hardware implementation, processing units used to perform the techniques may be implemented within one or more ASICs, DSPs, Digital Signal Processing Devices (DSPDs), Programmable Logic Devices (PLDs), Field Programmable Gate Arrays (FPGAs), processors, controllers, microcontrollers, microprocessors, electronic devices, other electronic units designed to perform the functions described in the present disclosure, a computer, or a combination thereof.

Accordingly, various illustrative logic blocks, modules, and circuits described in connection with the present disclosure may be implemented or performed with a general purpose processor, a DSP, an ASIC, an FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In a firmware and/or software implementation, the techniques may be implemented as instructions stored on a non-transitory computer-readable medium such as a Random Access Memory (RAM), a Read-Only Memory (ROM), a Non-Volatile Random Access Memory (NVRAM), a Programmable Read-Only Memory (PROM), an Erasable Programmable Read-Only Memory (EPROM), an Electrically Erasable PROM (EEPROM), a flash memory, a Compact Disc (CD), a magnetic or marking data storage device, and the like. The instructions may be executable by one or more processors and may cause the processor(s) to perform certain aspects of the functionality described in the present disclosure.

If implemented in software, the techniques described above may be stored on a non-transitory computer-readable medium as one or more instructions or code, or transmitted via a computer-readable medium. Non-transitory computer-readable media includes both computer storage media and communication media including any medium that facilitates transfer of a computer program from one place to another. Storage media may be any available media that may be accessed by a computer. By way of non-limiting example, such computer-readable media may include RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium.

For example, if software is transmitted from a website, server, or other remote source using wireless technologies such as coaxial cable, fiber optic cable, twisted pair, Digital Subscriber Line (DSL), or infrared, radio, and microwave, then coaxial cable, fiber optic cable, twisted pair, digital subscriber line, or wireless technologies such as infrared, radio, and microwave are included in the definition of medium. Disk and disc, as used herein, includes CD, laser disc, optical disc, Digital Versatile Disc (DVD), floppy disk and Blu-ray disc, where disks usually reproduce data magnetically, while discs reproduce data optically using lasers. Combinations of the above should also be included within the scope of computer-readable media.

A software module may reside in a RAM memory, a flash memory, a ROM memory, an EPROM memory, an EEPROM memory, registers, a hard disk, a removable disk, a CD-ROM, or any other form of storage medium known. An example storage medium may be coupled to the processor such that the processor may read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Although the examples described above have been described as utilizing aspects of the presently disclosed subject matter in one or more standalone computer systems, the present disclosure is not limited thereto, and may be implemented in conjunction with any computing environment, such as a network or distributed computing environment. Furthermore, aspects of the subject matter in the present disclosure may be implemented in a plurality of processing chips or devices, and storage may be similarly effected across a plurality of devices. Such devices may include PCs, network servers, and portable devices.

Some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. As used herein the term “and/or” includes any and all combinations of one or more of the associated listed items.

Although the present disclosure has been described in connection with some example embodiments, various modifications and changes may be made without departing from the scope of the present disclosure understandable by those skilled in the art to which the inventive concepts of the present disclosure pertain. Also, such modifications and changes should be considered to fall within the scope of the claims appended to the present disclosure.

What is claimed is:

1. A method for providing a message, the method being executed by at least one processor, and the method comprising:
identifying an event associated with a message request based on an instant messaging application;
obtaining second information from first information using an artificial neural network model, the first information being associated with a user account of the instant messaging application, and the second information being associated with at least one of,
a context associated with a timing of the identifying, or
a prompt associated with the event;
generating a first message based on the second information using the artificial neural network model; and
providing the first message through a first message room of the instant messaging application associated with the artificial neural network model.

2. The method as claimed in claim 1, wherein the identifying comprises:
providing a floating object on a first screen of the instant messaging application;
receiving a first user input selecting the floating object; and
identifying the receiving the first user input as the event.

3. The method as claimed in claim 2, wherein the providing the floating object comprises:
providing at least one of an icon, a logo, or a symbol associated with the artificial neural network model as the floating object.

4. The method as claimed in claim 2, wherein the providing the floating object comprises:
providing a second message associated with the context as the floating object.

5. The method as claimed in claim 1, wherein the identifying comprises:
receiving a second user input for entering the first message room based on the user account; and
identifying the receiving the second user input as the event.

6. The method as claimed in claim 1, wherein the identifying comprises:
receiving a third user input inputting the prompt into the first message room of the instant messaging application; and
identifying the receiving the third user input as the event.

7. The method as claimed in claim 1, wherein the obtaining the second information comprises:
identifying message information transmitted or received through at least one second message room of the instant messaging application associated with the user account as the first information.

8. The method as claimed in claim 1, wherein the obtaining the second information comprises:
identifying at least one of schedule information or memorandum information recorded through at least one service of the instant messaging application based on the user account as the first information.

9. The method as claimed in claim 1, wherein the obtaining the second information comprises:
identifying at least one of date information or weather information of the timing of the identifying as the context.

10. The method as claimed in claim 1, wherein the obtaining the second information comprises:
identifying the first information from a memory of an electronic device on which the instant messaging application is executed.

11. The method as claimed in claim 1, wherein the obtaining the second information comprises:
requesting at least a portion of the first information from an external electronic device associated with the instant messaging application; and
receiving the at least the portion of the first information from the external electronic device.

12. The method as claimed in claim 11, wherein the requesting the at least the portion of the first information comprises:
transmitting keyword information associated with the at least one of the context or the prompt to the external electronic device.

13. The method as claimed in claim 1, wherein the generating the first message comprises:
identifying a third message associated with the second information from among a plurality of messages, the plurality of messages being transmitted or received through at least one second message room of the instant messaging application associated with the user account.

14. The method as claimed in claim 13, wherein the providing the first message comprises:
providing a fourth message including the third message together with the first message.

15. The method as claimed in claim 14, wherein the providing the fourth message comprises:
providing at least one of user account information or date information associated with transmission of the third message in an area of the fourth message.

16. The method as claimed in claim 1, wherein the generating the first message comprises:
generating a fifth message supporting access to a website associated with the second information.

17. The method as claimed in claim 16, wherein the providing the first message comprises:
providing the fifth message together with the first message.

18. The method as claimed in claim 16, further comprising:
receiving a fourth user input selecting the first message; and
providing the fifth message in response to receiving the fourth user input.

19. A non-transitory computer-readable recording medium storing a computer program that, when executed in a computer, causes the computer to perform the method according to claim 1.

20. An electronic device comprising:
a memory storing instructions; and
at least one processor configured to execute the instructions to cause the electronic device to,
identify an event associated with a message request based on an instant messaging application,
obtain second information from first information using an artificial neural network model, the first information being associated with a user account of the instant messaging application, and the second information being associated with at least one of,
a context associated with a timing of identification of the event, or
a prompt associated with the event,
generate a first message based on the second information using the artificial neural network model, and
provide the first message through a first message room of the instant messaging application associated with the artificial neural network model.
